(19) United States
(12) Patent Application Publication
(10) Pub. No.: US 2026/0245961 A1
(43) Pub. Date: Aug. 20, 2026

(54) COMPOSITE POLYMER ELECTROLYTE FOR ALL SOLID-STATE BATTERY, MANUFACTURING METHOD THEREOF, AND ALL-SOLID-STATE BATTERY COMPRISING THE SAME

(71) Applicant: UIF (University Industry Foundation), Yonsei University, Seoul (KR)

(72) Inventors: Sang-young LEE, Seoul (KR); Kyeong-seok OH, Seoul (KR); Hyun Ho KWON, Seoul (KR)

(73) Assignee: UIF (University Industry Foundation), Yonsei University, Seoul (KR)

(21) Appl. No.: 19/432,674

(22) Filed: Dec. 24, 2025

(30) Foreign Application Priority Data
Feb. 19, 2025 (KR) 10-2025-0021474
Dec. 17, 2025 (KR) 10-2025-0202316

(51) Int. Cl. H01M 10/0565; H01M 4/02; H01M 4/38; H01M 4/505; H01M 4/525; H01M 4/58; H01M 4/583; H01M 10/0525; H01M 10/058

(52) U.S. Cl. CPC H01M 10/0565; H01M 4/382; H01M 4/386; H01M 4/505; H01M 4/525; H01M 4/582; H01M 4/5825; H01M 4/583; H01M 10/0525; H01M 10/058; H01M 2004/027; H01M 2004/028; H01M 2300/0082

(57) ABSTRACT

In the composite polymer electrolyte for an all-solid-state battery according to the present invention, lithium ions are coordinated in a double-coordinated form by cations bonded to the organic framework and cationic monomer and anions of the lithium salt inside the cationic organic framework, and this double coordination structure is continuously arranged along the pore structure of the organic framework, thereby forming an aligned lithium ion conduction channel. Through this, lithium ion conductivity and battery life characteristics can be improved, interfacial charge transfer resistance can be reduced, and lithium dendrite growth can be suppressed. In addition, the composite polymer electrolyte for an all-solid-state battery of the present invention can have excellent battery capacity and Coulombic efficiency even in rapid charging, and can further improve interfacial charge transfer resistance by controlling the content of the lithium salt to promote ion cluster enhancement and adjusting the anion coordination structure at the anode interface.

### CROSS-REFERENCES TO RELATED APPLICATIONS

This application claims priority to Korean Patent Application Nos. 10-2025-0021474 and 10-2025-0202316 filed on Feb. 19, 2025 and Dec. 17, 2025, respectively and all the benefits accruing therefrom under 35 U.S.C. 119, the contents of which in its entirety are herein incorporated by reference.

### BACKGROUND OF THE INVENTION

### Technical Field

The present invention relates to a composite polymer electrolyte for an all-solid-state battery, a manufacturing method thereof, and an all-solid-state battery comprising the same.

### Background Art

Lithium metal is in the spotlight as a next-generation battery anode material due to its high theoretical capacity and low oxidation-reduction potential. However, existing liquid electrolytes have poor compatibility with lithium metal anodes due to safety issues caused by high volatility and flammability. In addition, liquid electrolytes are prone to depletion by continuously reacting with the lithium metal anode.

Due to these problems, the transition to solid electrolytes for the use of lithium metal anodes is receiving great attention. However, inorganic solid electrolytes represented by Argyrodite-type Li6PS5Cl have many problems yet to be solved, such as low processability, poor interfacial contact, and reactivity with lithium metal.

Accordingly, polymer-based solid electrolytes with mild process conditions and excellent compatibility with lithium metal have been studied as the most promising candidates for electrolytes for lithium metal batteries. However, most studies on polymer electrolytes are only focusing on attempts to improve ionic conductivity, which is lower than that of liquid electrolytes and inorganic solid electrolytes, and studies dealing with interfacial properties that contribute more to the practical performance of lithium metal batteries are still insufficient.

The lithium metal interfacial properties of polymer electrolytes are limited to forming an inorganic-rich solid electrolyte interface layer and improving surface morphology by applying the initial liquid electrolyte as it is and using an excessive amount of salt or introducing an additive containing a fluorine (F) group. This stops at observing the static state of lithium metal and improving it partially, and does not consider the dynamic phenomena occurring at the actual interface at all.

### PRIOR ART DOCUMENT

1. Korean Patent Publication No. 2024-0075079

### BRIEF SUMMARY OF THE INVENTION

To solve the above problems, an object of the present invention is to provide a composite polymer electrolyte for an all-solid-state battery having improved interfacial charge transfer resistance and excellent lithium ion conductivity.

In addition, an object of the present invention is to provide an all-solid-state lithium metal battery comprising the composite polymer electrolyte according to the present invention.

In addition, an object of the present invention is to provide a device comprising the all-solid-state lithium metal battery according to the present invention.

In addition, an object of the present invention is to provide a manufacturing method of a composite polymer electrolyte for an all-solid-state battery.

The present invention is a dry composite polymer electrolyte for an all-solid-state battery formed by curing a curable composition comprising a cationic organic framework; a cationic monomer; a polyfunctional monomer containing 3 or more polymerizable functional groups; and a lithium salt; without a solvent, wherein in the composite polymer electrolyte, lithium ions are coordinated in a double-coordinated form by cations bonded to the organic framework and the cationic monomer and anions of the lithium salt inside the cationic framework, and this double coordination structure is continuously arranged along the pore structure of the organic framework, thereby forming an aligned lithium ion conduction channel.

In the present invention, ‘without a solvent’ means that substantially no solvent is included, and cases where a trace amount of residual solvent or solvent at an impurity level included unintentionally, for example, less than 5% by weight, or less than 1% by weight is contained, should also be considered to be included in the scope of ‘without a solvent’ of the present invention.

If a solvent is added, the diluted cationic polymer in ionic solvate electrolyte (cPISE) is impregnated into the COF, and Li+ conducts through solvent coordination. Due to these two factors, it is impossible to create the environment described in the present invention (double coordination-based conduction within the COF).

In addition, the present invention provides an all-solid-state lithium metal battery comprising a cathode; an anode; and the composite polymer electrolyte according to the present invention positioned between the cathode and the anode.

In addition, the present invention provides a device comprising the all-solid-state lithium metal battery according to the present invention, wherein the device is any one selected from a communication device, a transportation device, and an energy storage device.

In addition, the present invention provides a manufacturing method of a composite polymer electrolyte for an all-solid-state battery comprising the steps of preparing a curable composition comprising a cationic organic framework, a cationic monomer, a polyfunctional monomer containing 3 or more polymerizable functional groups, and a lithium salt without a solvent; pressurizing the curable composition to form a film; and curing the formed film to manufacture a composite polymer electrolyte.

The composite polymer electrolyte for an all-solid-state battery of the present invention prepares a curable composition or a curable composition comprising a cationic organic framework; a mixture of a cationic monomer and a polyfunctional monomer containing 3 or more polymerizable functional groups; and a lithium salt; by mixing a cationic monomer, a polyfunctional monomer containing 3 or more polymerizable functional groups, and a lithium salt into a cationic organic framework without a solvent and then cures it to manufacture a composite polymer electrolyte, whereby the lithium ions are coordinated in a double-coordinated form by cations bonded to the organic framework and cationic monomer and anions of the lithium salt inside the cationic organic framework, and this double coordination structure is continuously arranged along the pore structure of the organic framework to be aligned, thereby forming a lithium ion conduction channel, whereby lithium ion conductivity and battery life characteristics can be improved, interfacial charge transfer resistance can be reduced, and lithium dendrite growth can be suppressed.

In addition, the composite polymer electrolyte for an all-solid-state battery of the present invention can have excellent battery capacity and Coulombic efficiency even in rapid charging, and can further improve interfacial charge transfer resistance by controlling the content of the lithium salt to promote ion cluster enhancement and adjusting the anion coordination structure at the anode interface.

The effects of the present invention are not limited to the effects mentioned above. The effects of the present invention should be understood to include all effects inferable from the following description.

### BRIEF DESCRIPTION OF THE DRAWINGS

FIG. 1 is a diagram showing the configuration and double coordination structure of a composite polymer electrolyte for an all-solid-state battery according to the present invention.

FIG. 2 is a flowchart schematically showing a manufacturing method of a composite polymer electrolyte for an all-solid-state battery according to the present invention.

FIG. 3 is a graph of cation yield according to the counter anion in the COF of the composite polymer electrolytes prepared in Examples 1 to 3 and Comparative Examples 1 and 2 of the present invention.

FIG. 4 is a graph of lithium ion conductivity of the composite polymer electrolytes prepared in Examples 1 to 3 and Comparative Examples 1 and 2 of the present invention.

FIG. 5 is a graph of overpotential according to the weakening of decoordination of Example 1 of the present invention and the cationic organic framework (cCOF).

FIG. 6A is a current density graph and FIG. 6B is a charge transfer resistance graph according to the overpotential of the composite polymer electrolytes of Example 1 and Comparative Example 1 of the present invention.

FIG. 7A is a graph of life characteristics and FIG. 7B is a graph of battery capacity and Coulombic efficiency according to rapid charging of the lithium metal batteries prepared in Example 4 and Comparative Example 3 of the present invention.

### DETAILED DESCRIPTION OF THE INVENTION

Hereinafter, the present invention will be described in more detail with one embodiment.

The present invention relates to a composite polymer electrolyte for an all-solid-state battery, a manufacturing method thereof, and an all-solid-state battery comprising the same.

As described above, most studies on polymer electrolytes are only focusing on attempts to improve ionic conductivity, which is lower than that of liquid electrolytes and inorganic solid electrolytes, and studies dealing with interfacial properties that contribute more to the practical performance of lithium metal batteries are still insufficient. The lithium metal interfacial properties of polymer electrolytes are limited to forming an Inorganic-rich solid electrolyte interface layer and improving surface morphology by applying the initial liquid electrolyte as it is and using an excessive amount of salt or introducing an additive containing a fluorine (F) group. This stops at observing the static state of lithium metal and improving it partially, and does not consider the dynamic phenomena occurring at the actual interface at all.

Accordingly, in the present invention, in order to improve the incompatibility between the lithium metal anode and the existing electrolyte, by manufacturing a composite polymer electrolyte by curing a curable composition prepared by mixing a cationic monomer, a polyfunctional monomer containing 3 or more polymerizable functional groups, and a lithium salt into a cationic organic framework or a curable composition comprising a mixture of a cationic monomer and a polyfunctional monomer and a lithium salt in a cationic organic framework without a solvent, lithium ions are coordinated in a double-coordinated form by cations bonded to the organic framework and the cationic monomer and anions of the lithium salt inside the cationic organic framework, and this double coordination structure is continuously arranged along the pore structure of the organic framework, thereby forming an aligned lithium ion conduction channel.

Through this, lithium ion conductivity and battery life characteristics can be improved, interfacial charge transfer resistance can be reduced, and lithium dendrite growth can be suppressed. Furthermore, it can have excellent battery capacity and Coulombic efficiency even in rapid charging, and can further improve interfacial charge transfer resistance by controlling the content of the lithium salt to promote ion cluster enhancement and adjusting the anion coordination structure at the anode interface.

Specifically, the present invention provides (i) a dry composite polymer electrolyte for an all-solid-state battery formed by curing a curable composition comprising a cationic organic framework; a cationic monomer; a polyfunctional monomer; and a lithium salt; without a solvent.

In the composite polymer electrolyte, lithium ions are coordinated in a double coordinated form by cations bonded to the organic framework and cationic monomer and anions of the lithium salt inside the cationic organic framework, and this double coordination structure is continuously arranged along the pore structure of the organic framework, thereby forming an aligned lithium ion conduction channel.

The composite polymer electrolyte according to the present invention is a dry composite electrolyte that substantially does not contain a solvent, and in the stage before curing, the cationic monomer, polyfunctional monomer, and lithium salt exist in a high concentration state and can be efficiently permeated and oriented into the nanochannels formed along the pore structure of the aligned cationic organic framework.

On the other hand, in the case of manufacturing a composite electrolyte using a composition containing a solvent, the cationic monomer and polyfunctional monomer exist at a low concentration, so permeation and orientation into the nanochannels formed through the pore structure of the cationic organic framework are inhibited, and accordingly, the alignment that should be achieved along the pore structure is also significantly inhibited. In addition, if a solvent is present, lithium ions are solvated by solvent molecules and move mainly by solvent-mediated diffusion, so a coordination-based ion migration path formed continuously based on the double coordination structure is not established. As a result, the structural features and efficient lithium ion conduction path intended by the present invention may not be formed.

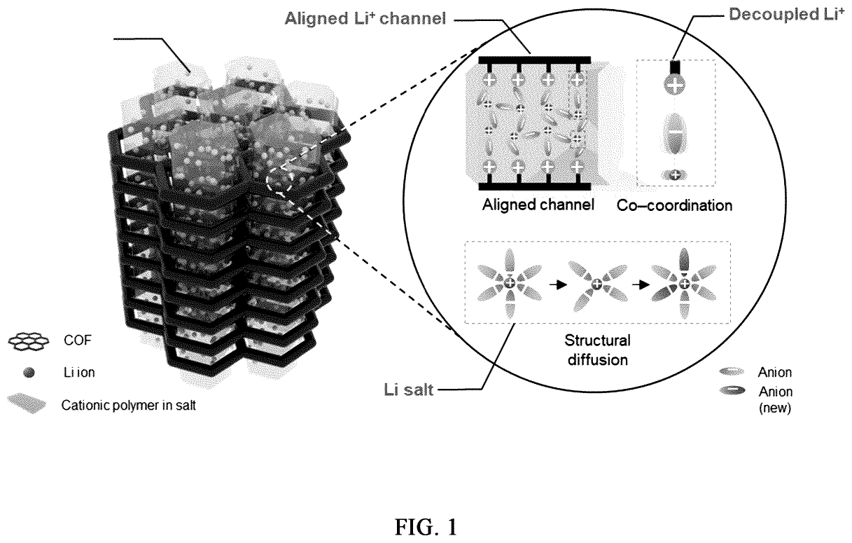

FIG. 1 is a diagram showing the configuration and double coordination structure of a composite polymer electrolyte for an all-solid-state battery according to the present invention. Referring to FIG. 1, the composite polymer electrolyte for an all-solid-state battery according to the present invention has a double coordination structure by the functional monomer which is a mobile phase and the anion of the lithium salt without the lithium ion directly interacting with the cationic organic framework/polymer matrix which is a stationary phase, so ion transport characteristics in the electrolyte can be improved. That is, the cationic organic framework and the cationic polymer matrix strongly interact with the anions of the lithium salt, and as the interaction between the anions and lithium ions becomes relatively weak, the selective mobility of lithium ions can be improved.

In addition, by increasing the content of lithium salt up to the solubility limit and increasing the ratio of anions included in the double coordination structure, the Li⁺ coordination energy decreases due to this, and during charging, the lithium metal anode is negatively polarized and anions are repelled at the anode surface, so the Li⁺ coordination energy at the electrolyte and anode interface can be further reduced. That is, by promoting anion decomposition at the lithium metal anode, a LiF-rich SEI is formed, so the interface is stabilized and lithium dendrite growth can be suppressed.

The cationic organic framework can effectively form an interlayer lithium ion channel to induce faster movement of lithium ions and can significantly improve ionic conductivity and energy density. The cationic organic framework may be composed of a structure represented by the following Formula 1.

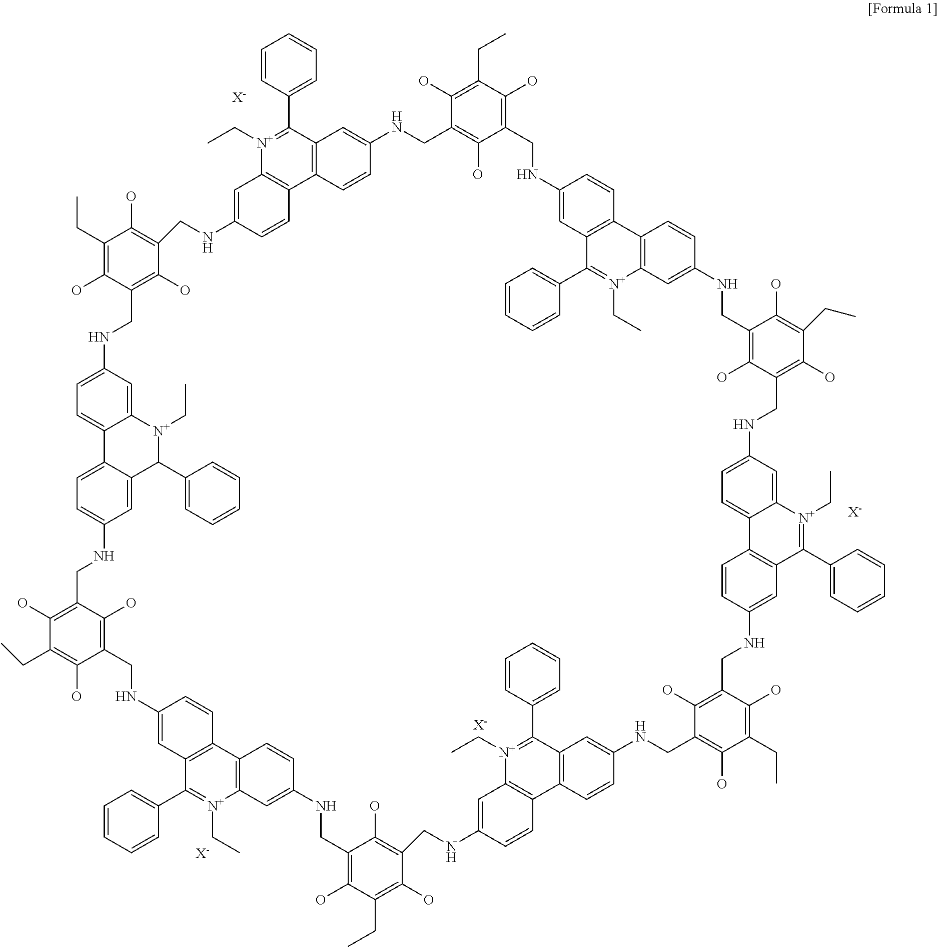

In Formula 1, X is a counter anion corresponding to the cation of the cationic organic framework structure.

The X may be a halogen element or an organic/inorganic anion, for example, it may be one or more selected from the group consisting of Cl⁻, Br⁻, NO₃⁻, BF₄⁻, PF₆⁻, SbF₆⁻, CF₃SO₃⁻ (OTf), (CF₃SO₂)₂N⁻ (TFSI), (FSO₂)₂N⁻ (FSI), (C₂F₅SO₂)₂N⁻ (BETI), (CF₃SO₂)₃C⁻, and combinations thereof.

According to an embodiment of the present invention, it is preferable that the X is an anion having a molecular volume equal to or larger than TFSI⁻ or having a structure in which the charge is delocalized. Specifically, the X may be OTf⁻, TFSI⁻, FSI⁻, BETI⁻, SbF₆⁻, PF₆⁻, or a derivative thereof.

When the X is TFSI⁻ or a bulky anion having a size similar to or larger than this, the charge of the anion is widely delocalized, so the electrostatic attraction with the cationic framework may be relatively weakened. This promotes dissociation of the lithium salt and creates an environment where lithium ions can move quickly inside the framework with less interference from anions. On the other hand, in the case of anions with small size and high charge density such as Br- or Cl-, the binding force with the cation in the framework acts strongly, so the effect of forming a lithium ion conduction channel by double coordination intended by the present invention may be relatively insignificant.

Preferably, in Formula 1, X may be OTf- or TFSI⁻, and most preferably, it may be TFSI⁻.

When X is TFSI⁻ as the cationic organic framework, compared to other counter anions, the binding energy between the lithium ion and the polar group of the polyfunctional monomer which is a mobile phase is further reduced, so lithium ion decoordination at the electrolyte and anode interface during charging becomes much easier, and due to this, interfacial charge transfer resistance can be significantly reduced.

The cationic organic framework may be a polygonal structure containing the repeating unit of Formula 1 on one side and having pores formed inside.

The pores of the cationic organic framework may have a diameter of 1 to 8 nm, preferably 1 to 3 nm, and most preferably 1.2 to 1.8 nm. At this time, if the pore diameter is less than 1 nm, the channel structure of aligned lithium ions may not be sufficiently formed, and conversely, if it exceeds 8 nm, the chemical structure of the cationic organic framework becomes unstable, and it may have low energy density during charging and discharging.

The cationic monomer and polyfunctional monomer may be mixtureized with each other to form a polymer matrix. The cationic monomer may act as an ion conduction channel, and the polyfunctional monomer may act as a crosslinker. In the present invention, due to the double coordination structure, the binding energy between lithium ions (Li⁺) and the polar group of the polyfunctional monomer is reduced, and due to this, Li⁺ decoordination at the electrolyte and anode interface becomes easy during charging, reducing interfacial charge transfer resistance and significantly suppressing lithium dendrite growth.

The cationic monomer may be one or more selected from the group consisting of diallyldimethylammonium-bistrifluoromethanesulfonimide (DADMA-TFSI), diallyldimethylammonium tetrafluoroborate (DADMA BF₄), diallyldimethylammonium hexafluorophosphate (PF₆DADMA), poly(diallyldimethyl ammonium) chloride ([P(DADMA)][Cl]), and poly(diallyldimethylammonium)bis(trifluoromethanesulfonyl)imide ([P(DADMA)][TFSI]), preferably diallyldimethylammonium-bistrifluoromethanesulfonimide, diallyldimethylammonium tetrafluoroborate, or a mixture thereof, and most preferably diallyldimethylammonium-bistrifluoromethanesulfonimide.

The polyfunctional monomer is a monomer containing 3 or more polymerizable functional groups, and may be one or more selected from the group consisting of trimethylolpropane propoxylate triacrylate, ethoxylated trimethylolpropane triacrylate, di(trimethylolpropane) tetraacrylate, diethylene glycol diacrylate, diethylene glycol dimethacrylate, ethylene glycol dimethacrylate, dipropylene glycol diacrylate, dipropylene glycol dimethacrylate, ethylene glycol divinyl ether, diethylene glycol divinyl ether, triethylene glycol dimethacrylate, dipentaerythritol pentaacrylate, trimethylolpropane triacrylate, trimethylolpropane trimethacrylate, and propoxylated trimethylolpropane triacrylate, preferably trimethylolpropane propoxylate triacrylate, ethoxylated trimethylolpropane triacrylate, or a mixture thereof, and most preferably trimethylolpropane propoxylate triacrylate.

The lithium salt may be one or more selected from the group consisting of LiTFSI (Lithium bis(fluorosulfonyl)imide), LiPF₆, LiBF₄, LiAsF₆, LiClO₄, LiNO₃, LiBOB ((lithium bis(oxalato) borate), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and LiTfO (lithium trifluoromethanesulfonate), preferably LiTFSI, LiPF₆, or a mixture thereof, and preferably LiTFSI.

The cationic organic framework may include 65 to 80% by weight, preferably 72 to 78% by weight, and most preferably 74 to 76% by weight with respect to 100% by weight of the curable composition. At this time, if the content of the cationic organic framework is less than 65% by weight, it is difficult to sufficiently form a lithium ion channel structure, which may hinder the fast movement of lithium ions, and conversely, if it exceeds 80% by weight, the yield of lithium ions relatively decreases, and lithium ion conductivity and energy density may decrease.

The curable composition may be photo-curing, thermal curing, or mixed curing thereof.

The composite polymer electrolyte may be in the form of a thin film having a thickness of 20 to 200 μm, preferably 20 to 70 μm, and most preferably 20 to 30 μm. If the thickness of the composite polymer electrolyte is less than 20 μm, the effect of suppressing lithium dendrite growth may not be sufficiently exhibited, and conversely, if it exceeds 200 μm, the interfacial charge transfer distance becomes longer, resistance may increase, and the performance of the battery may decrease.

The ionic conductivity of the composite polymer electrolyte may be 5×10⁻⁵ to 3.4×10⁻³ S/cm, preferably 1.1×10⁻⁴ to 2.0×10⁻³, and most preferably 2.1×10⁻⁴ to 4.5×10⁻⁴.

The room temperature charge transfer resistance of the composite polymer electrolyte may be 30 to 50Ω.

In the present invention, in order to form a composite electrolyte for an all-solid-state battery, a composite electrolyte can be manufactured by curing a curable composition comprising a cationic organic framework, a cationic monomer, a polyfunctional monomer, and a lithium salt. In particular, the composite polymer electrolyte according to a preferred embodiment is a dry composite electrolyte that substantially does not contain a solvent, and in the state where the cationic monomer, polyfunctional monomer, and lithium salt exist at a high concentration in the stage before curing, they can be effectively permeated and oriented into the nanochannels formed along the pore structure of the cationic organic framework. Thereby, a continuous lithium ion conduction structure based on double coordination is stably established inside the nanochannel after curing.

On the other hand, in the case of manufacturing a composite electrolyte using a composition containing a solvent, the cationic monomer and polyfunctional monomer are diluted by the solvent, so permeation and orientation into the nanochannels formed through the pore structure of the cationic organic framework are inhibited. In addition, as the solvent is present, lithium ions are solvated by solvent molecules and move mainly by solvent-mediated diffusion, so the establishment of a continuous coordination-based ion conduction structure based on the double coordination structure and an effective lithium ion conduction path is not sufficiently realized.

According to another preferred embodiment of the present invention, in the dry composite polymer electrolyte containing no solvent, when (i) the cationic organic framework consists of the structure represented by Formula 1, (ii) X is TFSI⁻ as a counter anion, and (iii) the average diameter of pores of the cationic organic framework is 1.2 to 1.8 nm, it is preferable because a lithium ion selective conduction path is formed within the pores, manifesting a heterogeneous ion conduction effect in which bulk ionic conductivity and lithium ion transference number (t+) are simultaneously improved. On the other hand, in the case of a gel-polymer electrolyte containing a solvent, or if any one of the above conditions is not met, the effect of simultaneously improving both of them, such as improving only one of bulk ionic conductivity and lithium ion transference number (t+), may not be manifested.

According to another preferred embodiment of the present invention, in the dry composite polymer electrolyte containing no solvent, when (i) the cationic organic framework consists of the structure represented by Formula 1, (ii) X is TFSI⁻ as a counter anion, (iii) the average diameter of pores of the cationic organic framework is 1.2 to 1.8 nm, (iv) the cationic monomer is diallyldimethylammonium-bistrifluoromethanesulfonimide, and (v) the polyfunctional monomer is trimethylolpropane propoxylate triacrylate, DADMA TFSI and TPPTA effectively permeate and orient into the nanochannels formed through the pore structure of the cationic organic framework while existing at high concentrations. It is more preferable because the ion-friendly continuous phase provided by DADMA-TFSI and the mechanical reinforcement phase provided by the TPPTA-derived crosslinking network coexist mutually continuously while having different dynamics at the nano/meso scale, thereby making it possible to simultaneously secure high ionic conductivity and excellent compressive/tensile strength at room temperature or higher. On the other hand, if a gel-polymer electrolyte containing a solvent is used, or if any one of the above conditions is not met, the monomer and lithium salt composition cannot effectively permeate/orient into the nanochannels in the stage before curing, and the formation ratio of the ion-friendly phase and the reinforcement phase may unintentionally change. Due to this, the conduction behavior of lithium ions appears differently from the way intended by the present invention, and the effect of simultaneously securing high ionic conductivity and mechanical strength at room temperature or higher may not be manifested.

According to another preferred embodiment of the present invention, in the dry composite polymer electrolyte containing no solvent, when (i) the cationic organic framework consists of the structure represented by Formula 1, (ii) X is TFSI⁻ as a counter anion, (iii) the average diameter of pores of the cationic organic framework is 1.2 to 1.8 nm, (iv) the cationic monomer is diallyldimethylammonium-bistrifluoromethanesulfonimide, (v) the polyfunctional monomer is trimethylolpropane propoxylate triacrylate, (vi) the cationic organic framework comprises 65 to 80% by weight with respect to 100% by weight of the curable composition, and (vii) the composite polymer electrolyte is in the form of a thin film having a thickness of 20 to 30 μm, it is even more preferable because a heterogeneous battery performance optimization effect is manifested in which a 3D ion conduction path is formed through the COF continuous framework, while simultaneously the polymer matrix acts as a stress buffer layer at the interface with the lithium metal electrode, and the total membrane resistance is minimized, securing low interfacial resistance, high capacity retention rate, and excellent cycle life all at the same time even under low temperature/high rate conditions. On the other hand, in the case of a gel-polymer electrolyte containing a solvent, or if any one of the above conditions is not met, such effects may not be manifested.

The composite polymer electrolyte according to the present invention forms a special type of double coordination structure composed of lithium ion (Li⁺)—functional monomer and anion of lithium salt—cation of cationic organic framework/cationic monomer, reducing the interaction due to electrostatic attraction between lithium ion (Li⁺) and the polymer matrix by mixing the cationic organic framework with a polymer matrix containing a cationic monomer and a polyfunctional monomer, thereby being able to weakly coordinate lithium ions. This double coordination structure promotes ion transport phenomena in the bulk electrolyte and can reduce charge transfer resistance at the interface as the weak attractive interaction between lithium ions and the cationic organic framework/polymer matrix acts dominantly. Furthermore, by controlling the content of the lithium salt, ion cluster enhancement can be promoted and the anion coordination structure at the anode interface can be adjusted, and through this, the interfacial charge transfer resistance can be further reduced.

In addition, the present invention provides an all-solid-state lithium metal battery comprising a cathode; an anode; and the composite polymer electrolyte according to the present invention positioned between the cathode and the anode.

Examples of cathode materials applicable to the present invention include Lithium-rich Layered Oxide (LLO), Lithium Nickel Manganese Oxide (LNMO), Lithium Nickel Cobalt Manganese (NCM), Lithium Nickel Cobalt Aluminum (LNCA), Lithium Iron Phosphate (LFP), Lithium Manganese Oxide (LMO), Lithium Cobalt Oxide (LCO), Lithium Manganese Iron Phosphate (LMFP), Lithium Nickel Oxide (LNO), Lithium Manganese Phosphate (LMP), Lithium Iron Manganese Phosphate (LFMP), Lithium Vanadium Phosphate (LVP), Lithium Iron Fluorosulfate (LFSF), etc., but are not limited thereto.

Examples of anode materials applicable to the present invention include lithium metal, silicon-carbon composite, tin-based alloy, silicon, lithium titanate (LTO), soft carbon, hard carbon, graphite, etc., but are not limited thereto.

In addition, the present invention provides a device comprising the all-solid-state lithium metal battery according to the present invention, wherein the device is any one selected from a communication device, a transportation device, and an energy storage device.

In addition, the present invention provides a manufacturing method of a composite polymer electrolyte for an all-solid-state battery comprising the steps of preparing a curable composition comprising a cationic organic framework, a cationic monomer, a polyfunctional monomer, and a lithium salt; pressurizing the curable composition to form a film; and curing the formed film to manufacture a composite polymer electrolyte.

Through this, in the composite polymer electrolyte, lithium ions are coordinated in a double coordinated form by cations bonded to the organic framework and cationic monomer and anions of the lithium salt inside the cationic organic framework, and this double coordination structure is continuously arranged along the pore structure of the organic framework, thereby forming an aligned lithium ion conduction channel.

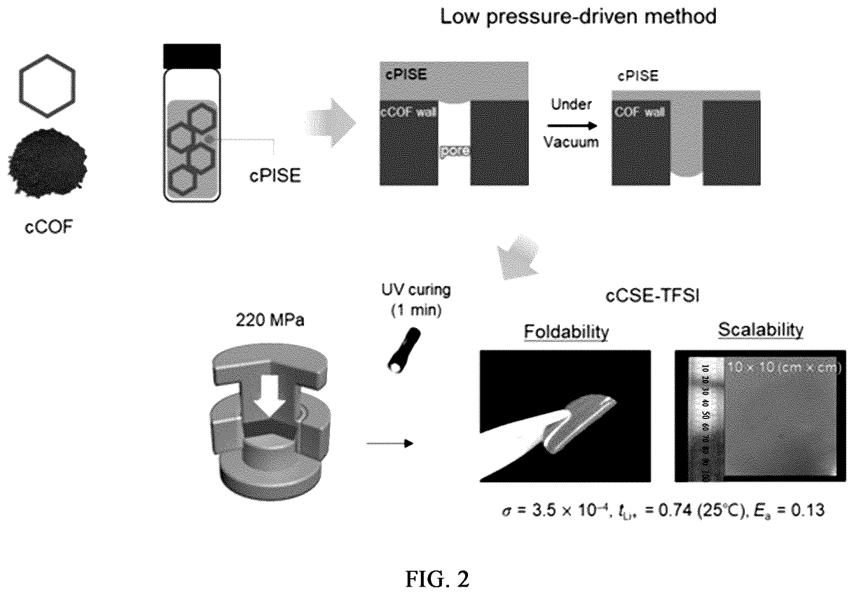

FIG. 2 is a flowchart schematically showing a manufacturing method of a composite polymer electrolyte for an all-solid-state battery according to the present invention. Referring to FIG. 2, it shows a method of manufacturing a curable composition comprising a cationic organic framework, a cationic monomer, a polyfunctional monomer, and a lithium salt, then pressurizing the curable composition by a low-pressure driven method to form a film, and subsequently photo-curing the formed film with UV to manufacture a composite polymer electrolyte in the form of a film.

The step of preparing the curable composition may include the steps of mixing a cationic monomer and a polyfunctional monomer to prepare a mixture; mixing a lithium salt into the mixture to prepare a mixture; and mixing a cationic organic framework into the mixture to prepare a curable composition.

In the step of forming the film, pressurization may be applying a pressure of 100 to 250 MPa, preferably 180 to 240 MPa, and most preferably 210 to 230 MPa.

In the step of manufacturing the composite polymer electrolyte, curing may be photo-curing by irradiating a UV lamp of 300 to 380 nm for 30 seconds to 2 minutes, preferably a UV lamp of 360 to 370 nm for 50 to 70 seconds.

The cationic organic framework may be composed of a structure represented by the following Formula 1.

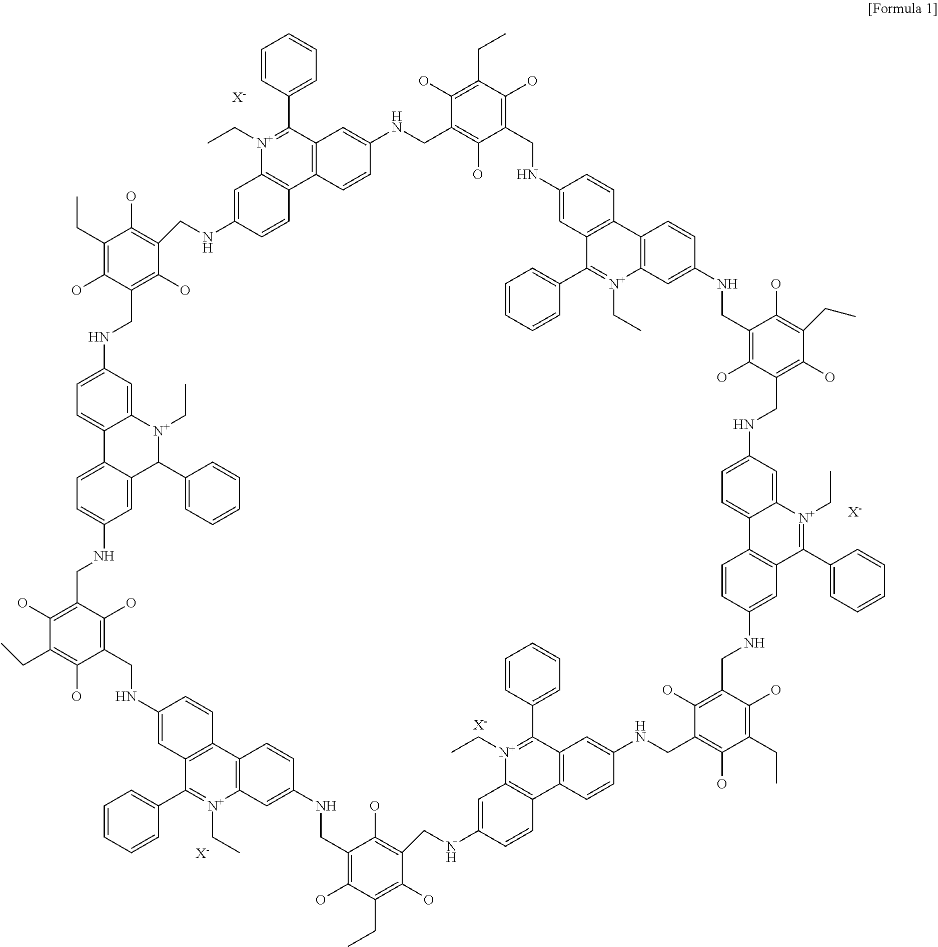

(In Formula 1, X is as defined above.)

The cationic monomer may be one or more selected from the group consisting of diallyldimethylammonium-bistrifluoromethanesulfonimide (DADMA-TFSI), diallyldimethylammonium tetrafluoroborate (DADMA BF4), diallyldimethylammonium hexafluorophosphate (PF6DADMA), poly(diallyldimethyl ammonium) chloride ([P(DADMA)][Cl]), and poly(diallyldimethylammonium)bis(trifluoromethanesulfonyl)imide ([P(DADMA)][TFSI]), preferably diallyldimethylammonium-bistrifluoromethanesulfonimide, diallyldimethylammonium tetrafluoroborate, or a mixture thereof, and most preferably diallyldimethylammonium-bistrifluoromethanesulfonimide.

The polyfunctional monomer may be one or more selected from the group consisting of trimethylolpropane propoxylate triacrylate, ethoxylated trimethylolpropane triacrylate, di(trimethylolpropane) tetraacrylate, diethylene glycol diacrylate, diethylene glycol dimethacrylate, ethylene glycol dimethacrylate, dipropylene glycol diacrylate, dipropylene glycol dimethacrylate, ethylene glycol divinyl ether, diethylene glycol divinyl ether, triethylene glycol dimethacrylate, dipentaerythritol pentaacrylate, trimethylolpropane triacrylate, trimethylolpropane trimethacrylate, and propoxylated trimethylolpropane triacrylate, preferably trimethylolpropane propoxylate triacrylate, ethoxylated trimethylolpropane triacrylate, or a mixture thereof, and most preferably trimethylolpropane propoxylate triacrylate.

The lithium salt may be one or more selected from the group consisting of LiPF₆, LiBF₄, LiAsF₆, LiClO₄, LiNO₃, LiBOB((lithium bis(oxalato) borate), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and LiTfO (lithium trifluoromethanesulfonate), preferably LiTFSI, LiPF6, or a mixture thereof, and preferably LiTFSI.

Hereinafter, the present invention will be described in more detail based on examples, but the present invention is not limited by the following examples.

### Example 1: Preparation of cCSE-TFSI Polymer Electrolyte

A cationic monomer DADMA-TFSI (Diallyl dimethyl ammonium-bis(trifluoromethane sulfonyl)imide) and a polyfunctional monomer TPPTA (Trimethylolpropane propoxylate triacrylate) were introduced at a molar ratio of 9:1 and then mixtureized to prepare a mixture. 2 parts by weight of AIBN (2,2′-Azobis(2-methylpropionitrile) as an initiator were mixed with respect to 100 parts by weight of the mixture. Next, the mixture and lithium salt LiTFSI (Lithium bis(fluorosulfonyl)imide) were mixed at a molar ratio of 1:1.5 to prepare a cPISE mixture. Next, a cationic organic framework cCOF-TFSI (1,3,5-triformylphloroglucinol ethidium) and the cPISE mixture were mixed at a weight ratio of 3:1 to prepare a curable composition cCSE-TFSI. A pressure of 220 MPa (3 ton) was applied to the cCSE-TFSI with a hydraulic press (Hefei Kejing Materials Technology Co., Ltd.) at 120° C. for 1 hour to form a film. A UV lamp of 365 nm was irradiated to the film for 1 minute to finally manufacture a composite polymer electrolyte in the form of a thin film with a thickness of about 30 μm.

### Example 2: Preparation of cCSE-OTf Polymer Electrolyte

A cCSE-OTf polymer electrolyte was prepared in the same manner as in Example 1, except that a cationic organic framework cCOF-OTf was used.

### Example 3: Preparation of cCSE-Br Polymer Electrolyte

A cCSE-Br polymer electrolyte was prepared in the same manner as in Example 1, except that a cationic organic framework cCOF-Br was used.

### Comparative Example 1: Preparation of cPISE Polymer Electrolyte

A cPISE polymer electrolyte in which the mixture of Example 1 and lithium salt LiTFSI (Lithium bis(fluorosulfonyl)imide) were mixed at a molar ratio of 1:1.5 was prepared.

### Comparative Example 2: Preparation of cSIP Polymer Electrolyte

A cSIP polymer electrolyte in which 1 mol of lithium salt LiTFSI (Lithium bis(fluorosulfonyl)imide) was mixed with 8 mol of the mixture of Example 1 was prepared.

### Example 4: Manufacture of Lithium Metal Battery

An all-solid-state lithium metal battery including a composite polymer electrolyte formed by an in-situ method was manufactured by injecting the composite polymer electrolyte of Example 1 into a battery, assembling it, and then heating it at a temperature of 110° C. for 3 hours.

### Comparative Example 3: Manufacture of Lithium Metal Battery

A lithium metal battery was manufactured in the same manner as in Example 4, except that a liquid polymer electrolyte containing 1 M LiTFSI lithium salt in a solvent mixture of DOL/DME was used instead of the composite polymer electrolyte.

### Experimental Example 1-1: Analysis of Lithium Ion Transference Number

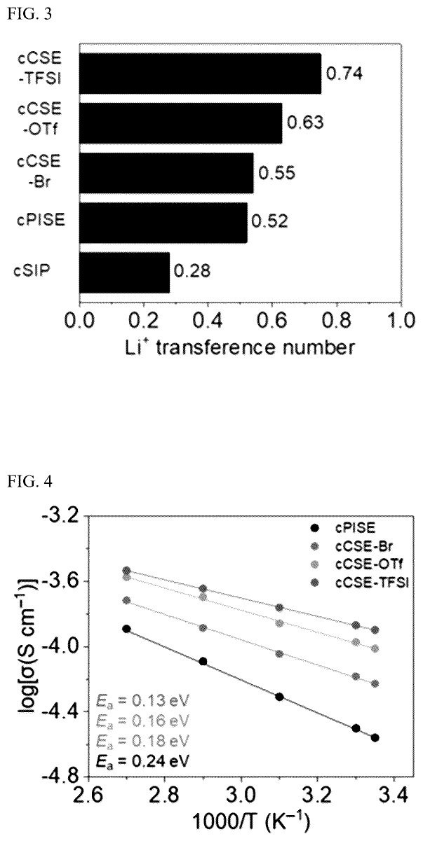

The lithium ion transference numbers were compared for the composite polymer electrolytes prepared in Examples 1 to 3 and Comparative Examples 1 and 2, and the results are shown in FIG. 3.

FIG. 3 is a graph of lithium ion transference number of the composite polymer electrolytes prepared in Examples 1 to 3 and Comparative Examples 1 and 2.

Referring to FIG. 3, in the case of Examples 1 to 3, the movement of lithium ions was active due to the aligned lithium ion channel structure, showing high values of lithium ion transference numbers of 0.74, 0.63, and 0.55, and in particular, Example 1 showed the highest lithium ion transference number. On the other hand, in the case of Comparative Example 1 (cPISE) and Comparative Example 2 (cSIP), it was confirmed that the absolute ionic conductivity values were low because an aligned lithium ion channel structure could not be formed. In addition, in the case of Comparative Example 2 (cSIP), the interaction due to electrostatic attraction between lithium ions and the polymer matrix acted strongly, showing a low cation yield, and in particular, it showed the lowest cation yield by including an excessive amount of polymer matrix.

### Experimental Example 1-2: Analysis of Lithium Ion Conductivity

The lithium ion conductivity was analyzed for the composite polymer electrolytes prepared in Examples 1 to 3 and Comparative Example 1, and the results are shown in FIG. 4 and Table 1.

FIG. 4 is a graph of lithium ion conductivity of the composite polymer electrolytes prepared in Examples 1 to 3 and Comparative Example 1.

TABLE 1

| | Li⁺ | | |
|---|---|---|---|
| | transference | Li⁺ | |
| | number | conductivity | E [symbol] |
| Electrolyte | — | mS cm⁻¹ | eV |
| cPISE | 0.52 | 0.029 | 0.24 |
| cCSE-Br | 0.54 | 0.05 | 0.18 |
| cCSE-OTf | 0.63 | 0.11 | 0.16 |
| cCSE-TFSI | 0.74 | 0.26 | 0.13 |

[symbol]

indicates data missing or illegible when filed

According to the results of FIG. 4 and Table 1, in the case of Examples 1 to 3, the lithium ion conductivities showed high values of 0.26, 0.11, and 0.05 mS/cm, respectively, due to the excellent lithium ion transference number. On the other hand, in the case of Comparative Example 1, it was confirmed that the lithium ion conductivity showed a low value of 0.029 mS/cm because it did not include a cationic organic framework.

### Experimental Example 2: Analysis of Overpotential and Charge Transfer Resistance

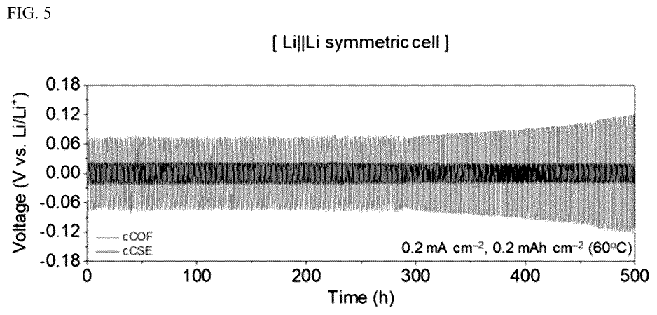

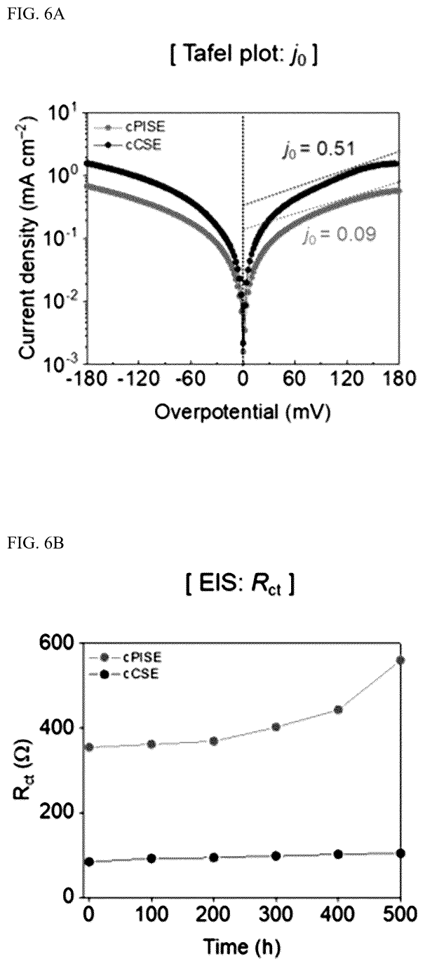

Lithium ion adsorption/desorption overpotential and charge transfer resistance were analyzed for the composite polymer electrolytes prepared in Example 1 and Comparative Example 1 under the conditions of a current density of 0.2 mA/cm2 and 0.2 mAh/cm2 (60° C.) at a temperature of 60° C., and the results are shown in FIGS. 5 and 6.

FIG. 5 is a graph of overpotential according to the weakening of decoordination of Example 1 and the cationic organic framework (cCOF).

According to the result of FIG. 5, in the case of Example 1, overpotential hardly occurred even over time and it showed a stable and constant voltage range, confirming that the battery performance was excellent.

FIG. 6A is a current density graph and FIG. 6B is a charge transfer resistance graph according to the overpotential of the composite polymer electrolytes of Example 1 and Comparative Example 1.

Referring to FIGS. 6A and 6B, in the case of Example 1, charge transfer resistance hardly occurred due to low overpotential, but in the case of Comparative Example 1, overpotential occurred over time, and it was confirmed that charge transfer resistance gradually increased significantly, especially after 200 hours.

### Experimental Example 3: Electrochemical Analysis According to Life Characteristics and Rapid Charging

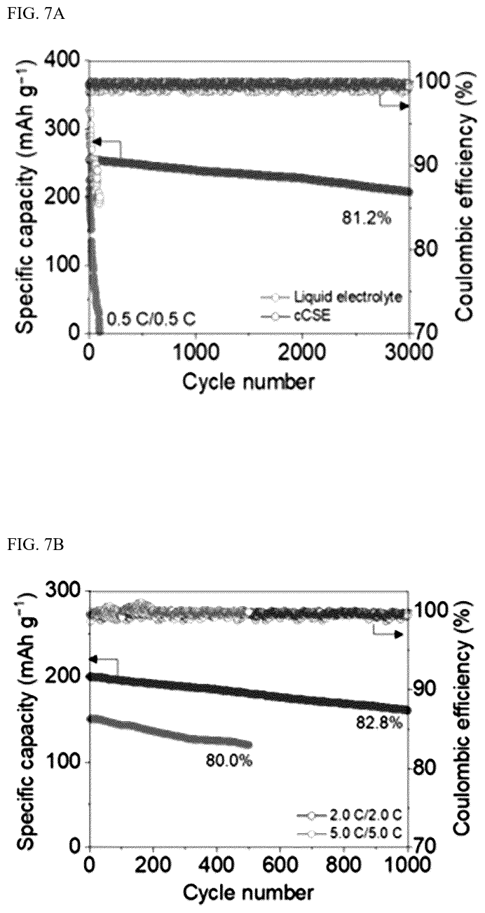

The electrochemical characteristics according to charging/discharging and electrochemical characteristics according to rapid charging of the lithium metal batteries manufactured in Example 4 and Comparative Example 3 were analyzed, and the results are shown in FIGS. 7A and 7B.

FIG. 7A is a graph of life characteristics and FIG. 7B is a graph of battery capacity and Coulombic efficiency according to rapid charging (b) of the lithium metal batteries prepared in Example 4 and Comparative Example 3.

Referring to FIG. 7A, in the case of Example 4, the battery capacity was maintained high even when the number of charge/discharge cycles increased in charging of 0.5 C/0.5 C, and the Coulombic efficiency was also maintained at 90% or more, and then slowly decreased to 81.2% at the point where the number of cycles was 3000. On the other hand, in the case of Comparative Example 3, the battery capacity and Coulombic efficiency drastically decreased as the number of cycles increased, so measurement was impossible.

Referring to FIG. 7B, in the case of Example 4, it was confirmed that the battery capacity was maintained high even when the number of cycles increased in charging of 2.0 C/2.0 C, and in the case of Coulombic efficiency, it decreased to 82.8% at the point where the number of cycles was 1000. Also, in the rapid charging of 5.0 C/5.0 C, the battery capacity was maintained high even up to 500 cycles, and the Coulombic efficiency decreased to 80%.

Through this, it could be seen that the lithium metal battery applying the solid electrolyte of the present invention has excellent stability during charge/discharge cycle life and rapid charging compared to existing batteries, and can effectively maintain battery capacity and Coulombic efficiency.

1. A composite polymer electrolyte for an all-solid-state battery formed by curing a curable composition comprising a cationic organic framework, a cationic monomer, a polyfunctional monomer containing 3 or more polymerizable functional groups, and a lithium salt.

2. The composite polymer electrolyte for an all-solid-state battery according to claim 1, wherein the cationic organic framework is composed of a structure represented by the following Formula 1, 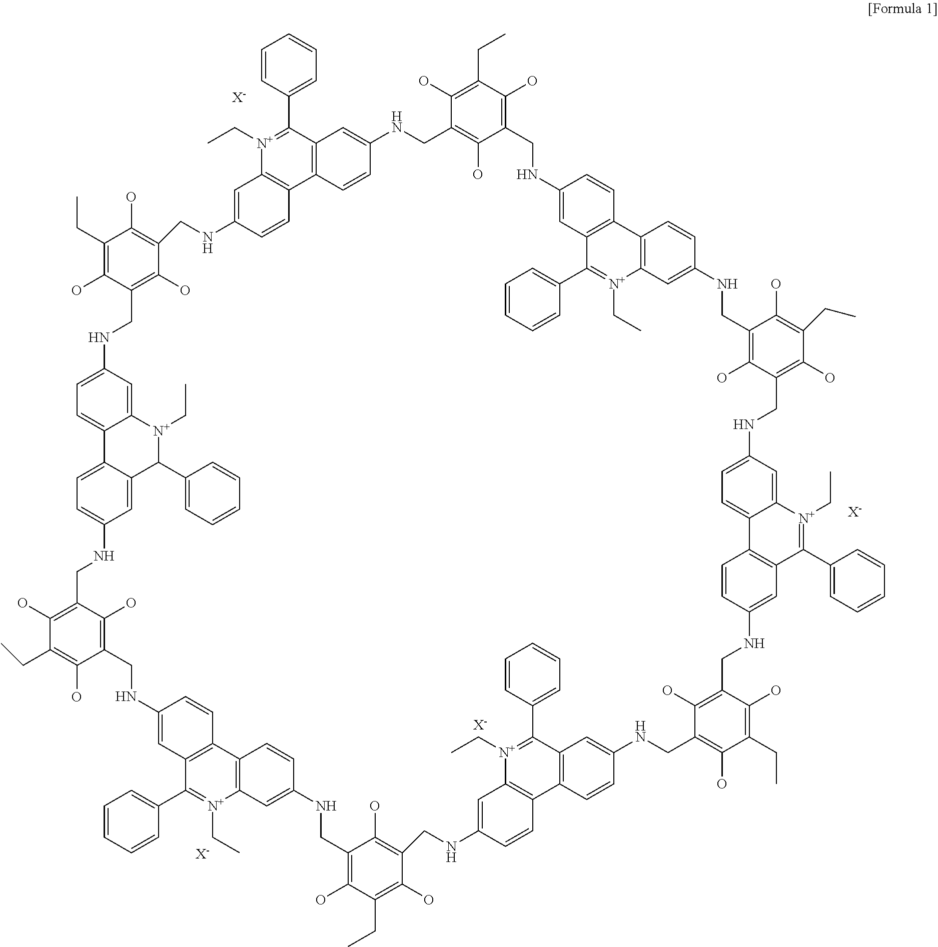
(In Formula 1, X is one or more selected from the group consisting of Cl⁻, Br⁻, NO₃⁻, BF₄⁻, PF₆⁻, SbF₆⁻, CF₃SO₃⁻ (OTf), (CF₃SO₂)₂N⁻ (TFSI), (FSO₂)₂N⁻ (FSI), (C₂F₅SO₂)₂N⁻ (BETI), (CF₃SO₂)₃C⁻, and combinations thereof as a counter anion.)

3. The composite polymer electrolyte for an all-solid-state battery according to claim 1, wherein the cationic organic framework is a polygonal structure containing the repeating unit of Formula 1 on one side and having pores formed inside.

4. The composite polymer electrolyte for an all-solid-state battery according to claim 1, wherein the pores of the cationic organic framework have a diameter of 1 to 8 nm.

5. The composite polymer electrolyte for an all-solid-state battery according to claim 1, wherein the cationic monomer is one or more selected from the group consisting of diallyldimethylammonium-bistrifluoromethanesulfonimide (DADMA-TFSI), diallyldimethylammonium tetrafluoroborate (DADMABF₄), diallyldimethylammonium hexafluorophosphate (PF₆DADMA), poly (diallyldimethyl ammonium) chloride ([P(DADMA)][Cl]), and poly(diallyldimethylammonium)bis(trifluoromethanesulfonyl)imide ([P(DADMA)][TFSI]);
the polyfunctional monomer is one or more selected from the group consisting of trimethylolpropane propoxylate triacrylate, ethoxylated trimethylolpropane triacrylate, di(trimethylolpropane) tetraacrylate, diethylene glycol diacrylate, diethylene glycol dimethacrylate, ethylene glycol dimethacrylate, dipropylene glycol diacrylate, dipropylene glycol dimethacrylate, ethylene glycol divinyl ether, diethylene glycol divinyl ether, triethylene glycol dimethacrylate, dipentaerythritol pentaacrylate, trimethylolpropane triacrylate, trimethylolpropane trimethacrylate, and propoxylated trimethylolpropane triacrylate; and
the lithium salt is one or more selected from the group consisting of LiTFSI (Lithium bis(fluorosulfonyl)imide), LiPF₆, LiBF₄, LiAsF₆, LiClO₄, LiNO₃, LiBOB ((lithium bis(oxalato) borate), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and LiTfO (lithium trifluoromethanesulfonate).

6. The composite polymer electrolyte for an all-solid-state battery according to claim 1, wherein the cationic organic framework comprises 65 to 80% by weight with respect to 100% by weight of the curable composition.

7. The composite polymer electrolyte for an all-solid-state battery according to claim 1, wherein the composite polymer electrolyte is in the form of a thin film having a thickness of 20 to 200 μm.

8. The composite polymer electrolyte for an all-solid-state battery according to claim 1, wherein the ionic conductivity of the composite polymer electrolyte is 5×10⁻⁵ to 3.4×10⁻³ S/cm.

9. The composite polymer electrolyte for an all-solid-state battery according to claim 1, wherein the room temperature charge transfer resistance of the composite polymer electrolyte is 30 to 50Ω.

10. The composite polymer electrolyte for an all-solid-state battery according to claim 1, wherein (i) the cationic organic framework is composed of the structure represented by Formula 1,
(ii) X is TFSI as a counter anion, and
(iii) the average diameter of pores of the cationic organic framework is 1.2 to 1.8 nm.

11. The composite polymer electrolyte for an all-solid-state battery according to claim 1, wherein (i) the cationic organic framework is composed of the structure represented by Formula 1,
(ii) X is TFSI⁻ as a counter anion,
(iii) the average diameter of pores of the cationic organic framework is 1.2 to 1.8 nm,
(iv) the cationic monomer is diallyldimethylammonium-bistrifluoromethanesulfonimide, and
(v) the polyfunctional monomer is trimethylolpropane propoxylate triacrylate.

12. The composite polymer electrolyte for an all-solid-state battery according to claim 1, wherein (i) the cationic organic framework is composed of the structure represented by Formula 1,
(ii) X is TFSI as a counter anion,
(iii) the average diameter of pores of the cationic organic framework is 1.2 to 1.8 nm,
(iv) the cationic monomer is diallyldimethylammonium-bistrifluoromethanesulfonimide,
(v) the polyfunctional monomer is trimethylolpropane propoxylate triacrylate,
(vi) the cationic organic framework comprises 65 to 80% by weight with respect to 100% by weight of the curable composition, and
(vii) the composite polymer electrolyte is in the form of a thin film having a thickness of 20 to 30 μm.

13. An all-solid-state lithium metal battery comprising a cathode; an anode; and the composite polymer electrolyte of claim 1 positioned between the cathode and the anode.

14. The all-solid-state lithium metal battery according to claim 13, wherein the cathode is one or more selected from the group consisting of Lithium-rich Layered Oxide (LLO), Lithium Nickel Manganese Oxide (LNMO), Lithium Nickel Cobalt Manganese (NCM), Lithium Nickel Cobalt Aluminum (LNCA), Lithium Iron Phosphate (LFP), Lithium Manganese Oxide (LMO), Lithium Cobalt Oxide (LCO), Lithium Manganese Iron Phosphate (LMFP), Lithium Nickel Oxide (LNO), Lithium Manganese Phosphate (LMP), Lithium Iron Manganese Phosphate (LFMP), Lithium Vanadium Phosphate (LVP), and Lithium Iron Fluorosulfate (LFSF); and
the anode is one or more selected from the group consisting of lithium metal, silicon-carbon composite, tin-based alloy, silicon, lithium titanate (LTO), soft carbon, hard carbon, and graphite.

15. A device comprising the all-solid-state lithium metal battery of claim 13, wherein the device is any one selected from a communication device, a transportation device, and an energy storage device.

16. A method of manufacturing a composite polymer electrolyte for an all-solid-state battery comprising the steps of:
preparing a curable composition comprising a cationic organic framework, a cationic monomer, a polyfunctional monomer, and a lithium salt;
pressurizing the curable composition to form a film; and
curing the formed film to manufacture a composite polymer electrolyte.

17. The method of manufacturing a composite polymer electrolyte for an all-solid-state battery according to claim 16, wherein the step of preparing the curable composition comprises:
mixing a cationic monomer and a polyfunctional monomer to prepare a mixture;
mixing a lithium salt into the mixture to prepare a mixture; and
mixing a cationic organic framework into the mixture to prepare a curable composition.

18. The method of manufacturing a composite polymer electrolyte for an all-solid-state battery according to claim 16, wherein in the step of forming the film, pressurization is applying a pressure of 100 to 250 MPa.

19. The method of manufacturing a composite polymer electrolyte for an all-solid-state battery according to claim 16, wherein in the step of manufacturing the composite polymer electrolyte, curing is photo-curing by irradiating a UV lamp of 300 to 380 nm for 30 seconds to 2 minutes.

20. The method of manufacturing a composite polymer electrolyte for an all-solid-state battery according to claim 16, wherein the cationic organic framework is composed of a structure represented by the following Formula 1. 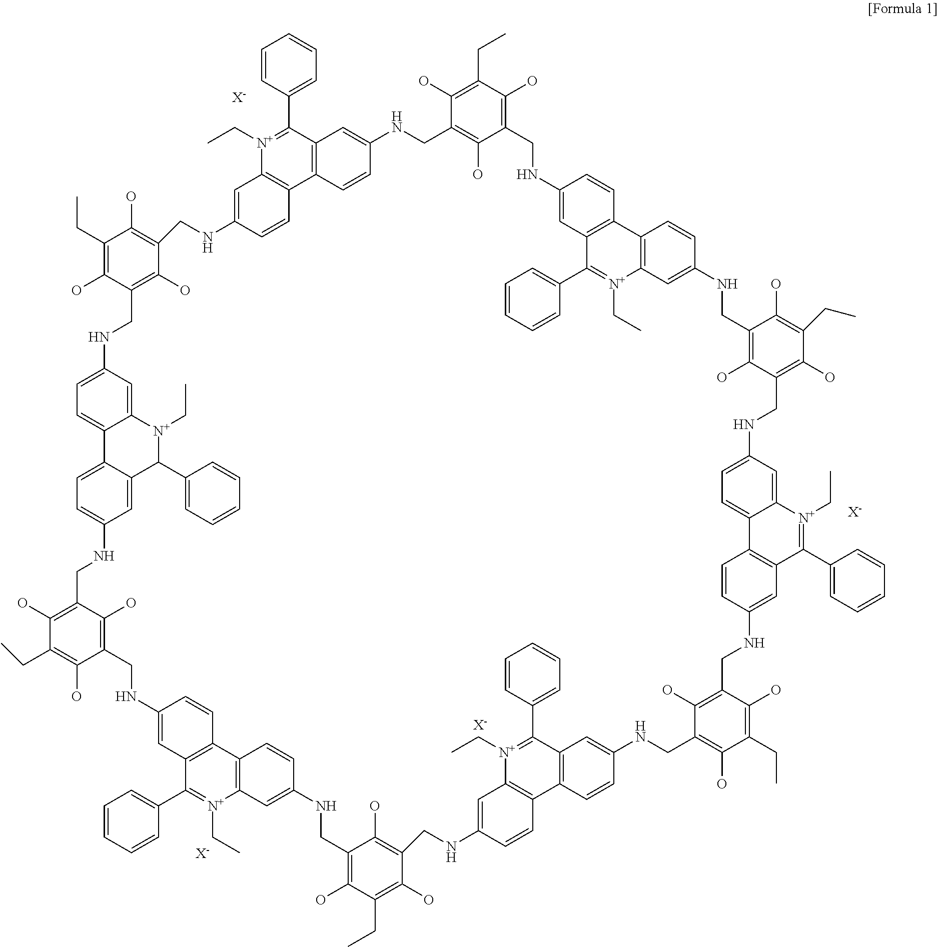
(In Formula 1, X is one or more selected from the group consisting of Cl⁻, Br⁻, NO₃⁻, BF₄⁻, PF₆⁻, SbF₆⁻, CF₃SO₃⁻ (OTf), (CF₃SO₂)₂N⁻ (TFSI), (FSO₂)₂N⁻ (FSI), (C₂F₅SO₂)₂N⁻ (BETI), (CF₃SO₂)₃C⁻, and combinations thereof as a counter anion.)

21. The method of manufacturing a composite polymer electrolyte for an all-solid-state battery according to claim 16, wherein (i) the cationic organic framework is composed of the structure represented by Formula 1,
(ii) X is TFSI⁻ as a counter anion, and
(iii) the average diameter of pores of the cationic organic framework is 1.2 to 1.8 nm.

22. The method of manufacturing a composite polymer electrolyte for an all-solid-state battery according to claim 16, wherein (i) the cationic organic framework is composed of the structure represented by Formula 1,
(ii) X is TFSI⁻ as a counter anion,
(iii) the average diameter of pores of the cationic organic framework is 1.2 to 1.8 nm,
(iv) the cationic monomer is diallyldimethylammonium-bistrifluoromethanesulfonimide, and
(v) the polyfunctional monomer is trimethylolpropane propoxylate triacrylate.

23. The method of manufacturing a composite polymer electrolyte for an all-solid-state battery according to claim 16, wherein (i) the cationic organic framework is composed of the structure represented by Formula 1,
(ii) X is TFSI⁻ as a counter anion,
(iii) the average diameter of pores of the cationic organic framework is 1.2 to 1.8 nm,
(iv) the cationic monomer is diallyldimethylammonium-bistrifluoromethanesulfonimide,
(v) the polyfunctional monomer is trimethylolpropane propoxylate triacrylate,
(vi) the cationic organic framework comprises 65 to 80% by weight with respect to 100% by weight of the curable composition, and
(vii) the composite polymer electrolyte is in the form of a thin film having a thickness of 20 to 30 μm.
